(19) United States
(12) Patent Application Publication
(10) Pub. No.: US 2007/0263060 A1
(43) Pub. Date: Nov. 15, 2007

(54) Hybrid Energy Curable Solvent-Based Liquid Printing Inks

(76) Inventors: Mikhail Laksin, Boonton, NJ (US); Subhankar Chatterjee, Hampton, NJ (US); David A. Biro, Rockaway, NJ (US)

Correspondence Address: DICKSTEIN SHAPIRO LLP, 1177 AVENUE OF THE AMERICAS (6TH AVENUE), NEW YORK, NY, 10036-2714, US

(21) Appl. No.: 10/586,098

(22) PCT Filed: Jan. 14, 2005
(86) PCT No.: PCT/US05/01245

§ 371 Date: Mar. 20, 2007

(51) Int. Cl. C09D 11/10

(52) U.S. Cl. 347/102; 106/31.13; 106/31.25

(57) ABSTRACT

The present invention provides a liquid printing ink that produces high quality flexographic or gravure printing images that have excellent solvent and abrasion resistance. In addition, the printing ink of the invention has high re-solubility, even after complete drying, upon contact with the liquid vehicle of the same ink, thereby preventing clogging of the printing plate, anilox or gravure cylinders over time. These characteristics of the printing ink are obtained by preparing a hybrid ink in which conventional organic solvent and/or water-based liquid inks are mixed with energy curable monomers and/or oligomers of resins and, optionally, a photoinitiator. After drying the ink, the printed images are exposed to an actinic radiation so that highly cross-linked polymers are formed in the printed images, which become water, chemical and abrasion-resistant.

### 1. INTRODUCTION

This invention relates to a printing ink, which can be used, for example, for inkjet printers, and is a hybrid between a conventional organic solvent- and/or water-soluble printing ink and inks containing energy curable (EC) monomers and/or oligomers of resin which can be cross-linked by an actinic radiation source, such as electron beam (EB), ultraviolet light (UV) and the like, with or without the presence of a photoinitiator. On one hand, the printing ink of the present invention has an excellent re-solubility, even after the complete drying, in the vehicle of same ink in a liquid form, thereby preventing clogging of the printing plate, anilox and/or gravure cylinders. On the other hand, once the printed ink is dried and exposed to irradiation, it is highly cross-linked and becomes resistant to chemicals, abrasion, water and moisture.

### 2. BACKGROUND OF THE INVENTION

Organic solvent- and/or water-based liquid flexo or gravure inks (“solvent-, based printing inks”) have been widely used in various types of printing, such as packaging, using inkjet printers. The printed images should have good solvent and abrasion resistance. At the same time, it is necessary for solvent-based printing inks to have good re-solubility to avoid ink drying and clogging on the plate, anilox and gravure cylinders of the printers. Typically, low molecular weight (MW) resins and plasticizers offer good re-solubility, yet, in order to improve resistance properties of the printed images, higher MW resins which have poor re-solubility are required. This represents a major contradiction and problem for the formulators of the solvent-based packaging liquid inks.

To solve these problems, various types of photocurable printing inks having specific combinations of photocurable resins and photoinitiators, have been developed (see, for example, U.S. Pat. No. 4,066,582; U.S. Pat. No. 4,221,686; U.S. Pat. No. 4,303,924; U.S. Pat. No. 5,057,398; and WO 01/57145 A1). However, incomplete polymerization of these inks often results in diffusion of uncured resins and causes smears or abrasion of the printed images.

### 3. SUMMARY OF INVENTION

The present invention is based, partly, on the discovery by the present inventors that organic solvent- and/or water-based liquid printing ink that comprises certain amounts of energy curable (EC) monomers and/or oligomers of resin in addition to conventional solvent-based ink components, has excellent re-solubility even after drying and, upon exposing to an actinic radiation, such as an electron beam (EB) and a ultraviolet light (UV), has improved resistance to chemicals, solvents, water and moisture, Namely, the present invention provides a hybrid energy curable solvent-based liquid printing ink. In a specific embodiment, the printing ink of the present invention comprises: (i) an organic solvent- and/or water-soluble resin; (ii) an energy curable monomer and/or oligomer resin; (iii) an organic solvent and/or water; and (iv) a photoinitiator in the case of using UV irradiation.

The term “actinic radiation” used herein refers to its broadest sense as any radiation that can produce photochemical reactions.

In another specific embodiment, the present invention provides a method for printing comprising: (i) printing a substrate with the printing ink of the present invention; (ii) drying the printed ink; and (iii) exposing the printed ink to a radiation. In a specific embodiment, the actinic radiation is an electron beam. In another embodiment, the actinic radiation is a UV light. In a preferred embodiment, steps (ii) and (iii) are performed simultaneously. In another preferred embodiment, steps (ii) and (iii) are performed sequentially.

### 4. DETAILED DESCRIPTION OF THE INVENTION

The present invention provides a solvent-based printing ink comprising: (i) a solvent-soluble resin; (ii) an energy curable monomer and/or oligomer; and (iii) an organic solvent and/or water. In a specific embodiment, the printing ink of the present invention further comprises (iv) a photoinitiator, when a UV light is used as a energy source for the polymerization of the energy curable resins. Thus, the present invention provides a hybrid printing ink between an energy curable ink and a conventional solvent-based ink. This combination is surprisingly advantageous in that the uncured energy curable component does not unduly interfere with the drying of the solvent soluble resin(s) and the dried ink is easily re-solubilized before the photopolymerization step even though it contains a quantity of the usually difficult to dissolve resin of conventional solvent-based inks and, thus, prevents cogging of orifices, plates, anilox and gravure cylinders of the printers. In addition, the presence of the cured solvent-based polymers intertwined with the highly cross-linked energy cured resins confers the printed images resistance to smearing, abrasion, chemicals, water and moisture. Furthermore, the limited amount of photocurable resin in the ink of the invention requires reduced amount of energy for complete polymerization and cross-linking than photocurable resin inks and diffusion of uncured monomers and/or oligomers can be eliminated.

Those skilled in the art will know that the printing ink of the present invention can also contain various additives, such as pigments, catalysts, drying oil, inhibitors for thermal polymerization of monomers, adhesion promoters, and so forth.

### 4.1. Organic Solvent- and/or Water-Soluble Resin

The organic solvent- and/or water-soluble resin used in the present invention includes any soluble polymers used in conventional solvent-based inks and are well known to one of ordinary skill in the art. The term “resin” used herein in relation to organic solvent- and/or water-soluble resin refers to both homopolymers and copolymers that are cross-linkable and are known as hard solid polymers. Preferably, such resins have relatively low weight average molecular weight (Mw). The preferred Mw is greater than about 500 but less than about 500,000 daltons, more preferably greater than about 1,000 but less than about 50,000 daltons, and most preferably greater than about 1,000 but less than about 10,000 daltons. The resins preferably have melting points at temperatures between about 0° and about 200° C., more preferably between about 10° C. and about 180° C., and most preferably between about 20° C. and 150° C. Examples of useful organic solvent- and/or water-soluble polymer resin includes, but not limited to, natural polymers, such as rosin based resins, cellulosic resins, such as nitrocellulose, carboxymethyl cellulose and ethyl hydroxyethyl cellulose; and synthetic polymers, such as polyamides, polyvinyl esters, polyvinyl acetals, polyvinyl ethers, epoxide resins, polyacrylic acid esters, polymethacrylic acid esters, polyesters, alkyd resins, polyacrylamide, polyvinyl alcohol, polyethylene oxide, polydimethyl acrylamide, polyvinyl pyrrolidone, polyvinylmethyl formamide, polyvinyl methyl acetamide, polyurethane, polystyrene resin, styrene-maleic anhydride copolymer (SMA), styrene-(meth)acrylate ester copolymer resin or styrene-conjugated diene copolymer resin, butyral resin, xylene resin, coumarone-indene resin, phenolic resin, as well as a mixture of or copolymer of those listed above.

In a preferred embodiment, an organic solvent- and/or water-soluble polymer is in a range between about 0.1% and about 40% by weight of the total ingredients of the ink, more preferably between about 1% and about 30% by weight of the total ink, and most preferably between about 10% and about 20% by weight of the total ink.

### 4.2. Energy Curable Resin

The energy curable resin or photocurable or photopolymerizable resin to be used in the present invention may be selected from the broad range of ethylenically unsaturated monofunctional or polyfunctional monomers and oligomers derived therefrom, capable of undergoing photopolymerization (see U.S. Pat. No. 4,066,582; JP H1-115974; WO 01/57145; WO 03/093378; and U.S. Pat. No. 6,706,777). The term “oligomer” as used herein refers to a low molecular weight polymer with degree of polymerization (DP) of less than about 10. Examples of suitable monomers are (poly)ester(meth)acrylates having at least one ester bond in the main chain; urethane(meth)acrylates having at least one urethane bond in the main chain; epoxyacrylates obtained by a reaction between (meth)acrylic acid and epoxide with one and more than one functional groups; (poly)ether (meth)acrylates having at least one ether bond in the main chain; allyl(meth)acrylates or alkylene(meth)acrylates comprising the main chain formed by a linear alkyl, a branched alkyl, a linear alkylene or a branched alkylene, and side chains or terminal ends having halogen atoms and/or hydroxyl groups; (meth)acrylates having an aromatic ring at the main chain or the side chain; (meth)acrylates having an alicyclic group having, in the main chain or the side chain, alicyclic groups which may include oxygen atoms or nitrogen atoms as the structural unit; and the like. It will be understood that “(meth)acrylate” is being used in its conventional sense to reference both acrylate and methacrylate.

Examples of (poly)ester(meth)acrylates include, but are not limited to, monofunctional (poly)ester(meth)acrylates such as alicyclic-modified neopentylglycol(meth)acrylate, caprolactone-modified 2-hydroxyethyl(meth)acrylate, ethyleneoxide- and/or propyleneoxide-modified phthalate(meth)acrylate, ethyleneoxide-modified succinate(meth)acrylate, caprolactone-modified tetrahydrofurfuryl(meth)acrylate; pivalate-esterneopentylglycoldi(meth)acrylate, caprolactone-modified hydroxypivalateesterneopentylglucoldi(meth)acrylate, epichlorohydrin-modified phthalatedi(meth)acrylate; mono-, di- or tri-(meth)acrylates of triol obtained by addition of more than 1 mole of cyclic lactones such as epsilon-caprolactone, gamma-butylolactone, delta-valerolactone or methylvalerolactone to 1 mole of trimethylolpropane or glycerin; mono-, di-, tri, or tetra-(meth)acrylates of triol obtained by addition of more than 1 mole of cyclic lactones such as epsilon-caprolactone, gamma-butylolactone, delta-valerolactone or methylvalerolactone to 1 mole of pentaerythritol or ditrimethylolpropane; mono- or poly-(meth)acrylates of polyhydric alcohols such as triol, tetraot, pentaol, or hexaol, obtained by addition of more than 1 mole of cyclic lactones such as epsilon-caprolactone, gamma-butylolactone, delta-valerolactone or methylvalerolactone to 1 mole of dipentaerythritol; (meth)acrylates of polyester polyols composed of diol components, such as (poly)ethylene glycol, (poly)propylene glycol, (poly)tetramethylene glycol, (poly)butylene glycol, (poly)pentanediol, (poly)methyl-pentanediol, and (poly)hexanediol, and polybasic adds such as maleic add, fumaric acid, succinic acid, adipic add, phthalic acid, hexahydrophitalic acid, tetrahydrophtalic acid, itaconic acid, citraconic acid, hettic acid, chlorendic acid, dimeric acid, alkenylsuccinic acid, sebacic acid, azelaic acid, 2,2,4-trimethladipic acid, 1,4-cyclo-hexanedicarboxylic acid, terephthalic acid, 2-sodium-sulfoterephthalic acid, 2-potassium sulfoterephthalic acid, isophthalic acid, 5-sodium sulfoisophthalic acid, 5-potassium sulfoisophthalic acid, orthophtalic acid, 4-sulfophthalic acid, 1,10-decamethylenedicarboxylic acid, muconic acid, oxalic acid, malonic acid, gultaric acid, trimellitic acid, pyromellitic acid; and polyfunctional (poly)ester (meth)acrylates composed of the above diol components, polybasic adds, and cyclic lactone-modified polyesterdiols such as epsilon-caprolactone, gamma-butylolactone, delta-valerolactone or methylvalerolactone.

Urethane(meth)acrylates represent (meth)acrylates obtained by a reaction between hydroxy compounds having at least one acryloyloxy group and isocyanate compounds. Urethane(meth)acrylate may also be selected from water dilutable aliphatic acrylate or aromatic urethanes. Examples of hydroxy compounds having at least one acryloyloxy group include, for example, 2-hydroxyethyl(meth)acrylate, 2-hydroxypropyl(meth)acrylate, 2-hydroxybutyl(meth)acrylate, 3-hydroxybutyl(meth)acrylate, 4-hydroxybutyl(meth)acrylate, cyclohexanedimethanolmono(meth)acrylate, polyethylene glycol(meth)acrylate, polypropylene glycol(meth)acrylate, trimethylolpropanedi(meth)acrylate, trimethylolethanedi(meth)acrylate, pentaerythritoltri(meth)acrylate or an adduct of (meth)acrylate with glycidyl(meth)acrylate, (meth)acrylate compounds having hydroxyl groups such as 2-hydroxy-3-phenolpropyl(meth)acrylate, and ring-opening reaction products of the above acrylate compounds having hydroxyl groups with epsilon-caprolactone.

Examples of isocyanate compounds include, for example, aromatic diisocyanates such as p-phenylenediisocyanate, m-phenylenediisocyanate, p-xylenediisocyanate, m-xylenediisocyanate, 2,4-tolylenediisocyanate, 2,6-tolylenediisocyanate, 4,4′-diphenylmethanediisocyanate, 3,3′-dimethyldiphenyl-4,4′-diisocyanate, 3,3′-diethyldiphenyl-4,4′-diisocyanate, and naphthalenediisocyanate; aliphatic or alicyclic diisocyanates, such as isophoronediisocyanate, hexamethylenediisocyanate, 4,4′-dicyclohexylmethanedlisocyanate, hydrogenated xylenediisocyanate, norbornenediisocyanate, and lysinediisocyanate; polyisocyanates, such as buret products of more tan one type of isocyanates and isocyanate-trimers of the above isocyanates; and polyisocyanates obtained by the esterification reaction of the above isocyanate with various polyols. Examples of polyols used to produce polyisocyanates include, but are not limited to, (poly)alkylene glycols such as (poly)ethylene glycol, (poly)propylene glycol (poly)butylene glycol, and (poly)tetramethylene glycol; alkyleneglycols modified by ethyleneoxide, proxpyleneoxide, butyleneoxide, tetrahydrofuran, epsilon-carprolactone, gamma-butylolactone, delta-varlerolactone or methylvalerolactone, such as ethylene glycol, propanediol, propylene glycol, tetramethylene glycol, pentamethylolpropane, hexanediol neopentyl glycol, glycerin, trimethylolpropane, pentaerythriol, diglycerin, ditrimethylolpropane, and dipentaerythritol; aliphatic polyols such as copolymers of ethyleneoxide and propyleneoxide, copolymers of propylene glycol and tetrahydrofuran, copolymers of ethylene glycol and tetrahydrofuran, polyisoprene glycol hydrogenated polyisoprene glycol, polybutadiene glycol, and hydrogenated polybutadiene glycol; aliphatic polyester polyols obtained by esterification reactions between aliphatic dicarboxylic acids such as adipic acid and dimeric acid with polyols such as neopentyl glycols and methpentanediol; aromatic polyester polyols obtained by esterification reaction between aromatic dicarboxylic acids, such as terephthalic acid with polyols, such as neopentyl glycol; polycarbonatepolyols; acrylpolyols; polyhydric alcohols, such as polytetrameththlenehexaglyceryl ether (hexaglycerin modified by tetrahydrofuran); mono- or polyhydric compounds having an ether group at a terminal; polyhydric compound obtained by esterification of the compound having polyhydroxyl groups with dicarboxylic acids, such as fumaric acid, phthalic acid, isophthaic acid, itaconic acid, adipic acid, sebacic acid, and maleic acid; compound containing polyhydroxyl groups such as monoglyceride obtained by transesterification reaction of compound having polyhydroxyl groups such as glycerin with ester of fatty acid of animals or plants.

Epoxy(meth)acrylates are obtained by a reaction of epoxides having more than one functional group and (meth)acrylic acid. Epoxides as the raw material for epoxy(meth)acrylates includes, but are not limited to, epichlorhydrin-modified-hydrogenated bisphenol-type epoxy resin, synthesized by (methyl)epichlorohydrin and compounds such as hydrogenated bisphenol A, hydrogenated bisphenol S, hydrogenated bisphenol F, and their modified compounds with ethylene oxide or propylene oxide; alicyclic epoxy resins such as 3,4-epoxycyclohexylmethyl-3,4-epoxycyclo hexane carboxy-late, bis-(3,4-epoxycyclohexyl)adipate; alicyclic epoxides such as epoxy resin containing heterocycles such as triglycidylisocyanurate; epichlorohydrin-modified bisphenol-type epoxy resins synthesized by a reaction of (methyl)epichlorohydrin and a compound such as bisphenol A, bisphenol S, bisphenol P, and their modified compounds with ethylene oxide or propyleneoxide; phenol Novolak type epoxy resins; cresol Novolak type epoxy resins; epoxy resins of dicyclopentadiene-modified phenol resin obtained by the reaction of dicyclopentadiene and various types of phenol resins; an aromatic epoxidized compounds of 2,2′,6,6′-tetramethylbis-phenol; aromatic epoxides such as phenylglycidyl ether; (poly)glycidyl ethers of glycol compounds such as poly)ethylene glycol, (poly)propylene glycol, (poly)butylene glycol, (poly)tetramethylene glycol, neopentyl glycol; (poly)glycidyl ether of glycols modified with alkylene oxide; (poly)glycidyl ethers of aliphatic polyhydric alcohols, such as trimethylolpropane, trimethylolethane, glycerin, diglycerin, erythritol, pentaerythritol, sorbitol, 1,4-butanediol, 1,6-hexanediol; alkylene type epoxides of (poly)glycidyl ether modified of aliphatic polyhydric alcohols by alkylene; glycidylesters of carboxylic acids, such as adipic acid, sebacic acid, maleic acid, and itaconic acid; glycidyl ethers of polyesterpolyols of polyhydric alcohols with polycarboxylic acids; a copolymer of glycidyl(meth)acrylate or methylglycidyl(meth)acrylate; glycidylester of higher fatty adds; aliphatic epoxy resins, such as an epoxidized linseed oil, an epoxidized castor oil, and an epoxidized polybutadiene.

(Poly)ether(meth)acrylates include, but are not limited to, aliphatic epoxy acrylates, monofunctional (poly)ether(meth)acrylates, such as butoxyethyl(meth)acrylate, butoxytriethylene glycol(meth)acrylate, epichlorohydrin-modified butyl(meth)acrylate, dicyclopentenyloxylethyl(meth)acrylate, 2-ethoxyethyl(meth)acrylate, ethylcarbitol(meth)acrylate, 2-methoxy(poly)ethylene glycol(meth)acrylate, methoxy(poly)propylene glycol(meth)acrylate, nonylphenoxypolyethylene glycol(meth)acrylate, nonylphenoxypolypropylene glycol(meth)acrylate, phenoxyhydroxypropyl(meth)acrylate, phenoxy(poly)ethylene glycol(meth)acrylate, polyethylene glycol mono(meth)acrylate, polypropylene glycol mono(meth)acrylate, and polyethylene glycol, polypropylene glycol mono(meth)acrylate; alkylene glycol di(meth)acrylates such as polyethylene glycol di(meth)acrylate, polypropylene glycol di(meth)acrylate, polybutylene glycol di(meth)acrylate, polytetramethylene glycol di(meth)acrylate; polyfunctional (meth)acrylates induced by (meth)acrylic acid with aliphatic polyols, such as a copolymer of ethylene oxide and propylene oxide, a copolymer of propylene glycol and tetrahydrofuran, a copolymer of ethylene glycol and tetrahydrofuran, polyisoprene glycol, hydrogenated polyisoprene glycol, polybutadieneglycol, hydrogenated polybutadiene glycol; polyfunctional (meth)acrylates induced by acrylic acid with polyhydric alcohols such as polytetramethylenehexaglyceryl ether (tetrahydrofuran-modified hexaglycerin); di(meth)acrylates of diol obtained by addition of equimolar or more than 1 mole of cyclic ethers, such as ethylene oxide, propylene oxide, butylene oxide and/or tetrahydrofuran to 1 mole of neopentyl oxide; di(meth)acrylates of allylene oxides-modified bisphenols, such as bisphenol A, bisphenol F and bisphenol S; di(meth)acrylate of alkylene oxide-modified hydrogenated bisphenols, such as hydrogenated bisphenol A, hydrogenated bisphenol F, hydrogenated bisphenol S; di(meth)acrylates of alkylene oxide-modified trisphenols; di(meth)acrylates of alkylene oxide-modified hydrogenated trisphenols; di(meth)acrylates of alkylene oxide-modified p,p′-bisphenols; di(meth)acrylates of alkylene oxide-modified hydrogenated bisphenols; di(meth)acrylates of alkylene oxide-modified p,p′-dihydroxybenzophenones; mono-, di-, and tri-(meth)acrylates of triols obtained by addition of equimolar or more than 1 mole of ethylene oxide, propylene oxide, butylene oxide, and/or cyclic ethers such as tetrahydrofuran to 1 mole of trimethylolpropane or glycerin; mono-, di-, tri- or tetra-(meth)acrylates obtained by addition of equimolar or more than 1 mole of ethylene oxide, propylene oxide, butylene oxide, and/or cyclic ethers, such as tetrahydrofuran to 1 mole of pentaerythritol, ditrimethylolpropane or highly alkoxylated trimethylolpropane triacrylate; monofunctional (poly)ether(meth)acrylates or polyfunctional (poly)ether(meth)acrylates of polyhydric alcohols such as triol, tetraol, pentaol, or hexaol of mono- or poly-(meth)acrylates obtained by addition of equimolar or more than 1 mole of ethylene oxide, propylene oxide, butylene oxide, and/or cyclic ethers, such as tetrahydrofuran to 1 mole of dipentaerythritol.

Alkyl(meth)acrylates or alkylene(meth)acrylates include, but are not limited to, monofunctional (meth)acrylates, such as methyl(meth)acrylate, ethyl(meth)acrylate, propyl(meth)acrylate, isopropyl(meth)acrylate, butyl(meth)acrylate, isobutyl(meth)acrylate, pentyl(meth)acrylate, isopentyl (meth)acrylate, neopentyl(meth)acrylate, hexyl(meth)acrylate, heptyl(meth)acrylate, 2-ethylhexyl(meth)acrylate, octyl (meth)acrylate, isooctyl(meth)acrylate, nonyl(meth)acrylate, decyl(meth)acrylate, dodecyl(meth)acrylate, tridecyl (meth)acrylate, pentadecyl(meth)acrylate, miristyl (meth)acrylate, palmityl(meth)acrylate, stearyl(meth)acrylate, neryl(meth)acrylate, geranyl(meth)acrylate, farnecyl(meth)acrylate, hexadecyl(meth)acrylate, octadecyl(meth)acrylate, dodecyl(meth)acrylate, and trans-2-hexene(meth)acrylate; di(meth)acrylates of aliphatic diols such as ethylene glycol di(meth)acrylate, propylene glycol di(meth)acrylate, 1,2-butylene glycol di(meth)acrylate, 1,3-butylene glycol di(meth)acrylate, 1,4-butanediol di(meth)acrylate, 1,6-hexanediol di(meth)acrylate, neopentyl glycol di(meth)acrylate, 2-methyl-1,8-octanediol di(meth)acrylate, 1,9-nonanediol di(meth)acrylate, and 1,10-decanediol di(meth) acrylate; mono(meth)acrylates or poly(meth)acrylates of polyhydric alcohols such as trimethylolpropane, (hereinafter, the term “poly” is used as the general term of the poly-functional including di, tri, tetra, and poly compounds such as mono(meth)acrylate, di(meth)acrylate, and tri(meth)acrylate of trimethylolpropane), and mono(meth)acrylates or poly(meth)acrylates of polyhydric alcohols, such as triol, tetraol, and hexaol, for example, glycerin, pentaerythritol, ditrimethylolpropane, and dipentaerythritol; (meth)acrylates having hydroxyl groups such as 2-hydroxyethyl(meth)acrylate, 2-hydroxypropyl(meth)acrylate, 4-hydroxybutyl(meth)acrylate, 3-chloro-2-hydroxyethyl(meth)acrylate; (meth)acrylates having bromine atoms such as 2,3-dibromopropyl(meth)acrylate, tribromophenyl(meth)acrylate, ethylene oxide-modified tribromophenyl(meth)acrylate, ethylene oxide-modified tetrabromobisphenol A di(meth)acrylate; (meth)acrylates having fluorine atoms such as trifluoroethyl(meth)acrylate, pentafluoropropyl(meth)acrylate, tetrafluoropropyl(meth)acrylate, octafluoropentyl(meth)acrylate, dodecafluoroheptyl (meth)acrylate, hexadecafluorononyl(meth)acrylate, hexafluorobutyl(meth)acrylate, 3-perfluorobutyl-2-hydroxypropyl(meth)acrylate, 3-perfluorohexyl-2-hydroxypropyl(meth)acrylate, 3-perfluorooctyl-2-hydroxypropyl(meth)acrylate, 3-(perfluoro-5-methylhexyl)-2-hydroxypropyl(meth)acrylate, 3-(perfluoro-7-methyloctyl)-2-hydroxypropyl(meth)acrylate, and 3-(perfluoro-8-methyldecyl)-2-hydroxypropyl(meth)acrylate.

(Meth)acrylates having aromatic groups include, for example, but are not limited to, monofunctional (meth)acrylates, such as phenyl(meth)acrylate, benzylacrylate; and di(meth)acrylates, such as bisphenol A diacrylate, bisphenol F diacrylate, bisphenol S diacrylate.

(Meth)acrylates having alicyclic groups include, but not by way of limitation, monofunctional (meth)acrylates having alicyclic structures, such as cyclohexyl(meth)acrylate, cyclopentyl(meth)acrylate, cycloheptyl(meth)acrylate, bicycloheptyl(meth)acrylate, isobornyl(meth)acrylate, bicyclopentyldi(meth)acrylate, tricyclodecyl(meth)acrylate, bicyclopentenyl(meth)acrylate, norbornyl(meth)acrylate, bicyclooctyl(meth)acrylate, tricycloheptyl(meth)acrylate, and cholesteroid skeleton-substituted(meth)acrylate; di(meth)acrylates of hydrogenated bisphenols, such as hydrogenated bisphenol A, hydrogenated bisphenol F, hydrogenated bisphenol S, di(meth)acrylates of hydrogenated trisphenols, such as hydrogenated trisphenols, and di(meth)acrylates of hydrogenated p,p′-bisphenols; polyfunctional (meth)acrylates having cyclic structures such as dicyclopentane type di(meth)acrylate, such as “Kayarad R684” (available from Nihon Kayaku Co., Japan), tricyclodecane dimethyloldi(meth)acrylate, bisphenolfluorene dihydroxy(meth)acrylate; and alicyclic acrylates having oxygen atoms and/or nitrogen atoms, such as tetrahydrofurfuryl(meth)acrylate, and morpholinoethyl(meth)acrylate.

Compounds having acryloyl groups or methacryloyl groups which are suitable for the present invention, beside the above recited compounds, include poly(meth)acryl(meth)acrylates, such as a reaction product of (meth)acrylic acid polymer and glycidyl(meth)acrylate, and a reaction product of glycidyl(meth)acrylate polymer and (meth)acrylic acid; (meth)acrylate having amino groups such as dimethylaminoethyl(meth)acrylate; isocyanul(meth)acrylates, such as tris(meth)acryloxyethyl isocyanurate; phosphagene(meth)acrylates, such as hexakis(meth)acryloyloxyethyl cyclotriphosphagen; (meth)acrylate having a skeleton of polysiloxane; polybutadiene(meth)acrylate; and melamine(meth)acrylate. Among these compounds having acryloyl or methacryloyl group, it is preferable to use the compound having 1 to 6 acryloyl or methacryloyl groups.

(Meth)acrylamide derivatives which can be used in the present invention include, for example, monofunctional (meth)acrylamides, such as N-isopropyl(meth)acrylanide; and polyfunctional (meth)acrylamides, such as methylenebis(meth)acrylamide.

Compounds having vinyl ether groups suitable for the present invention include, but are not limited to, those containing: an alkyl vinyl ether having a terminal group substituted with at least one selected from the group consisting of a hydrogen atom, a halogen atom, a hydroxyl group, and an amino group; a cycloalkyl vinyl ether having a terminal group substituted with at least one selected from the group consisting of a hydrogen atom, a halogen atom, a hydroxyl group, and an amino group; at least one vinyl ether selected from the group consisting of a monovinyl ether, a divinyl ether, and a polyvinyl ether in which a vinyl ether group is connected with alkylene group; and a vinyl ether group connected with at least one group with and without substituent selected from the group consisting of alkyl group, cycloalkyl group, and aromatic group, via at least one linkage selected from the group consisting of an ether linkage, an urethane linkage, and an ester linkage.

Alkylvinyl ethers include, but are not limited to, methyl vinyl ether, hydroxymethyl vinyl ether, chloromethyl vinyl ether, ethyl vinyl ether, 2-hydroxyethylvinylether, 2-chloroethylvinylether, diethyl aminoethyl vinyl ether, propyl vinyl ether, 3-hydroxypropyl vinyl ether, 2-hydroxypropyl vinyl ether, 3-chloropropyl vinyl ether, 3-aminopropyl vinyl ether, isopropyl vinyl ether, butyl vinyl ether, 4-hydroxybutyl vinyl ether, isobutyl vinyl ether, 4-aminobutyl vinyl ether, pentyl vinyl ether, isopentyl vinyl ether, hexyl vinyl ether, 1,6-hexanediol monovinyl ether, heptyl vinyl ether, 2-ethylhexyl vinyl ether, octyl vinyl ether, isooctyl vinyl ether, nonyl vinyl ether, isononyl vinyl ether, decyl vinyl ether, isodecyl vinyl ether, dodecyl vinyl ether, isododecyl vinyl ether, tridecyl vinyl ether, isotridecyl vinyl ether, pentadecyl vinyl ether, isopentadecyl vinyl ether, hexadecyl vinyl ether, octadecyl vinyl ether, methylene glycol divinyl ether, ethylene glycol divinyl ether, propylene glycol divinyl ether, 1,4-butanediol divinyl ether, 1,6-hexanediol divinyl ether, cyclohexanediol divinyl ether, trimethylolpropane trivinyl ether, pentaerythritol tetravinyl ether and hexanedioic acid, bis[4-ethenyloxy)butyl]ester.

Cycloalkyl vinyl ethers suitable for the present invention include, but not by way of limitation, cyclopropyl vinyl ether, 2-hydroxycyclopropyl vinyl ether, 2-chloro-cyclopropyl vinyl ether, cyclopropylmethyl vinyl ether, cyclobutyl vinyl ether, 3-hydroxycyclobutyl vinyl ether, 3-chlorocyclobutyl vinyl ether, cyclobutylmethyl vinyl ether, cyclopentyl vinyl ether, 3-hydroxycyclopentyl vinyl ether, 3-chlorocyclopentyl vinyl ether, cyclopentylmethyl vinyl ether, cyclohexyl vinyl ether, 4-hydroxycyclohexyl vinyl ether, cyclohexylmethyl vinyl ether, 4-aminocyclohexyl vinyl ether, cyclohexanediol monovinyl ether, cyclohexanedimethanol monovinyl ether, and cyclohexanedimethanol divinyl ether. Compounds containing monovinyl ethers, divinyl ethers, and/or polyvinyl ethers, include those in which the vinyl ether linkage connects with an alkylene group, and at least one group selected from a group consisting of a C₂-C₂₄ alkyl group, a C₂-C₂₄ alicyclic group and a C₂-C₂₄ aromatic group which may have a substituents connecting with a linkage selected from the group consisting of an ether linkage, an urethane linkage, and an ester linkage. Examples of the compounds containing an ether linkage include, but are not limited to, ethylene glycol methyl vinyl ether, diethylene glycol monovinyl ether, diethylene glycol methylvinyl ether, diethylene glycol divinyl ether, triethylene glycol monovinyl ether, triethylene glycol methylvinyl ether, triethylene glycol divinyl ether, polyethylene glycol monovinyl ether polyethylene glycol methylvinylether, polyethylene glycol divinyl ether, propylene glycol methylvinyl ether, dipropylene glycol monovinyl ether, dipropylene glycol methylvinyl ether, dipropylene glycol divinyl ether, tripropylene glycol monovinyl ether, tripropylene glycol methylvinyl ether, tripropylene glycol divinyl ether, polypropylene glycol monovinyl ether, polypropylene glycol methylvinyl ether, polypropylene glycol divinyl ether, tetramethylene glycol methylvinyl ether, di(tetramethylene glycol)monovinyl ether, di(tetramethylene glycol)methyl vinyl ether, di(tetramethylene glycol)divinylether, tri(tetramethylene glycol)monovinyl ether, tri(tetramethylene glycol)methylvinyl ether, tri(tetramethylene glycol)divinyl ether, poly(tetramethylene glycol)monovinyl ether, poly(tetramethylene glycol)methylvinyl ether, poly(tetramethylene glycol)divinyl ether, 1,6-hexanediolmethyl vinyl ether, di(hexamethylene glycol)monovinyl ether, di(hexamethylene glycol)methylvinyl ether, di(hexamethylene glycol)divinyl ether, tri(hexamethylene glycol)monovinyl ether, tri(hexamethylene glycol)methylvinyl ether, tri(hexamethylene glycol)divinyl ether, poly(hexamethylene glycol)monovinyl ether, poly(hexamethylene glycol)methylvinyl ether, poly(hexamethylene glycol)divinyl ether.

In a preferred embodiment, the energy curable monomer and/or oligomers are in a range between about 1% and about 50%, more preferably between about 1.5% and about 40%, and most preferably between about 2% and about 30% by weight of the total ingredients of the ink.

The types of actinic radiation to polymerize photocurable ink of the invention may be an electron beam, or a UV light, and the like. In a preferred embodiment, the energy source for photo-polymerization is an electron beam. Preferably, an electron beam dose necessary for curing of the ink ranges between about 0.5 to about 8 Mrads, more preferably about 1 to about 6 Mrads, and most preferably about 1.5 to about 4 Mrads. An electron beam acceleration voltage ranges preferably about 50-200 kV, more preferably 60-165 kV, and most preferably about 70-140 kV. During the electron-beam curing of the ink, an inert environment is provided by nitrogen gas, resulting in preferably less than about 600 parts per million (ppm), more preferably less than about 400 ppm, and most preferably less than about 200 ppm, of O₂ present in the environment. In another preferred embodiment, the energy source for photo-polymerization is a UV light. An appropriate UV light may be obtained from, for example, a metal halide lamp, a xenon lamp, a carbon arc light source, a chemical lamp, a low-pressure or high-pressure mercury lamp, and so forth. The UV light intensity required for photopolymerizing the printed ink of the present invention is in the range of about 40 to about 10,000 mJ/cm², preferably about 50 to about 1,000 mJ/cm², and most preferably about 60 to about 600 mJ/cm².

### 4.3. Photoinitiator

Unless the actinic radiation source is an electron beam, the energy curable liquid printing ink of the present invention will typically contain a photoinitiator that generates free radicals upon exposure to actinic radiation, such as UV light. Such a photoinitiator may have one or more compounds that directly produce free radicals when activated by actinic radiation. The photoinitiator may also contain a sensitizer or activator which either extends the spectral response into the near ultraviolet, visible or near infrared spectral regions, or affects the rate of reaction. In free radical initiated curing systems, irradiation of a photoinitiator produces free radicals that initiate polymerization and/or crosslinking of photocurable resins. Various types of photoinitiators are well known to one of ordinary skill in the art (see, for example, “Photoinitiators for free-radical-initiated photoimaging systems” by Monroe, B. M. et al., 1994, Chem. Rev. 93:435-448). Examples of photoinitiators suitable for the present invention include, but not limited to, organic halogen compound as disclosed in U.S. Pat. No. 5,057,398 and those disclosed in U.S. Pat. No. 4,066,582, such as benzophenone, acetophenone, fluorenone, xanthone, thioxanthone, carbazole, benzoin, the allyl benzoin ethers, 2- or 3- or 4-bromoacetophenone, 3- or 4-allylacetophenone, m- or p-diacetylbenzene, 2- or 3- or 4-methoxybenzophenone, 3,3′- or 3,4′- or 4,4′-dimethoxybenzophenone, 4-chloro-4′-benzylbenzophenone, 2- or 3-chloroxanthone, 3,9-dichloroxanthone, 2- or 3-chlorothioxanthone, 3-chloro-8-nonylxanthone, 3-methoxyanthone, 3-iodixanthone, 2-acetyl-4-methylphenyl acetate, alkyl and aryl ethers of benzoin, phenylglyoxal alkyl acetals, 2,2′-dimethoxy-2-phenyl-acetophenone, 2,2-diethoxyacetophenone, 2,2-diiso-propoxyacetophenone, 1,3-diphenyl acetone, naphthalene sulfonyl chloride, and mixtures thereof.

Suitable sensitizers or activators that can be used in combination with the aforementioned photoinitiators include, but not by way of limitation, methylamine, tributylamine, methyldiethanolamine, 2-aminoethylethanolamine, allylamine, cyclohexylamine, cyclopentadienylamine, diphenylamine, ditolylanine, trixylylamine, tribenzylamine, N-cyclohexylethylenimine, piperidine, 2-methylpiperidine, N-ethylpiperidine, 1,2,3,4-tetrahydropyridine, 2- or 3- or 4-picoline, morpholine, N-methylmorpholine, piperazine, N-methylpiperazine, 2,2-dimethyl-1,3-bis-(3-N-morpholinyl) propionyloxy)) diethyl ether, isopropylthioxanthone (TTX), dibutoxyanthracene, dipropoxyanthracene, and mixtures thereof.

In a preferred embodiment, the photoinitiator is in a range between about 0.1% and about 20%, more preferably between about 0.2% to 12%, and most preferably about 0.5% to 8%, by weight of the total weight of the ink.

### 4.4. Vehicle

Any vehicle which has previously been used in printing inks may be used for the present invention. Typical are solvents that are low in viscosity and compatible with any other components of the ink. Thus, a choice of solvents depends on the types of the resin components as well as the type of photoinitiator selected for the printing ink of the present invention. Usable solvents for the present printing ink include, but not by way of limitation, water; alcohols, such as ethanol, methanol, isopropanol and n-butanol; esters, such as ethyl acetate, isopropyl acetate, butyl acetate (BuAc) and 2-ethoxyethyl acetate; glycol-ethers, such as 2-methoxyethanol, 2-ethoxyethanol, 2-butoxyethanol, 2-methoxyethoxethanol, 2-ethoxyethoxethanol and 2-butoxyethoxethanol; aliphatics, such as VM&P Naptha and mineral spirits; aromatics, such as toluol and xylol; ketones, such as acetone, methyl ethyl ketone (MEK) and methyl isobutyl ketone (MIBK) and other solvents, such as methylene chloride, 1,1,1-trichloroethane, N-methyl-2-pyrrolidone, dimethylsulfoxide, mesityl oxide, dimethyl formamide, thiophene, and so forth.

In a preferred embodiment, water and/or low molecular weight aliphatic alcohol, such as methanol, ethanol and isopropyl alcohol, or ester, such as ethyl acetate, may be used. In a preferred embodiment, the vehicle is in a range between about 1% and about 90%, more preferably about 30% and 85%, and most preferably about 45% and about 75%, by weight of the total weight of the printing ink of the invention.

### 5. EXAMPLES

The following examples illustrate the energy curable solvent-based liquid printing ink provided by the present invention. These examples should not be construed as limiting.

The solvent-based blue polyurethane liquid ink (SL-800, Sun Chemical, N.J.) used in Comparative Examples 1 and 2 and Examples 1 and 2, infra, had the following general composition:

| | | |
|---|---|---|
| Cyan blue pigment | 12-18 | wt % |
| N-propyl acetate/n-propanol (20:80) | 30-60 | wt % |
| Ethanol | 8-12 | wt % |
| Silica | 0-2 | wt % |
| Polyurethane resin | 10-20 | wt % |
| Additives (proprietary) | 0-2 | wt %. |

The solvent-based red liquid ink Flexomax, Sun Chemical) used in Comparative Examples 3 and 3′ and Example 3, infra, had the following general composition:

| | | |
|---|---|---|
| Rubine pigment | 14-20 | wt % |
| N-propyl acetate/n-propanol (20:80) | 25-65 | wt % |
| Glycol ethers | 6-10 | wt % |
| Polyurethane resin | 10-20 | wt % |
| Nitrocellulose | 10-15 | wt % |
| Additives (proprietary) | 0-2 | wt %. |

### Comparative Example 1

A 75-μ thick opaque polyethylene film was coated with a solvent-based blue polyurethane liquid ink (Sun Chemical SL-800) using a flexographic press (Chestnut, Fairfield, N.J.) and dried using a gas fired hot air oven. The gloss was measured using a 60° reflective glossmeter (micro-TRI-gloss BYK-Gardner, Silver Spring, Md.). Rub resistance was tested using isopropanol and a mixture of n-propyl acetate/n-propanol (20:80), respectively. Results are shown in Table 1 below.

### Example 1

A 75-μ thick opaque polyethylene film was coated with a solvent-based blue polyurethane liquid ink (Sun Chemical SL-800) containing 5% polyester acrylate (Ebecryl 812, Surface Specialties, Syrmna, Ga.) using a flexographic press (Chestnut, Fairfield, N.J.) and dried using a gas fired hot air oven. The film was electron beam cured at 3 Mrads, 125 kV acceleration voltage and less than 200 ppm O₂. Gloss measurement and rub resistance test were performed as described above. Results are shown in Table 1 below.

### Comparative Example 2

A 75-μ thick opaque polyethylene film was coated with a solvent-based red (polyureane/nitrocellulose) liquid ink (Flexomax, Sun Chemical) containing 10% polyester acrylate (Ebecryl 812, Surface Specialties, Syrmna, Ga.) using a 200 line per inch (lpi) flexographic hand-proofer and dried using a hot air gun. Gloss measurement and rub resistance test were performed as described above. Results are shown in Table 1 below.

### Example 2

A 75 micron thick opaque polyethylene film was coated with a solvent-based red (polyurethane/nitrocellulose) liquid ink (Flexomax, Sun Chemical) containing 10% polyester acrylate (Ebecryl 812, Surface Specialties, Syrmna, Ga.) using a 200 line per inch (lpi) flexographic hand-proofer and dried using a hot air gun. The ink was subsequently electron beam cured (AEB, lab-100, Wilmington, Mass.) at 3 Mrads using 100 kV acceleration voltage and less than 200 ppm O₂. Gloss measurement and rub resistance test were performed as described above. Results are shown in Table 1 below.

TABLE 1

| | Comparative | | Comparative | |
|---|---|---|---|---|
| Property | Example 1 | Example 1 | Example 2 | Example 2 |
| 60° Gloss¹ | F | G | F | E |
| Isopropanol | P | G | F | E |
| Resistance² | | | | |
| n-propyl acetate/ | P | G | P | E |
| n-propanol | | | | |
| (20:80) | | | | |
| resistance² | | | | |
| Water | G | E | G | E |
| resistance³ | | | | |

¹Gloss: 85-88 = poor (P); 89-91 = fair (F); 92-94 = good (G); and 95-97 = excellent (E).
²Solvent resistance: 0-1 double rub (a rub back and forth) = P; 2-4 = F; 5-9 = G; >10 = E.
³Water resistance: 10-20 = G; 20-40 = E.

### Comparative Example 3

A 48-μ transparent oriented polypropylene film was coated with a solvent-based red (polyurethane/nitrocellulose) liquid ink (Flexomax, Sun Chemical) using a 200 line per inch (lpi) flexographic hand-proofer and dried using a hot air gun. The gloss was measured using a 600 glossmeter (micro-TRI-gloss BYK-Gardner, Silver Spring, Md.) and solvent resistance was evaluated with water, a mixture of n-propyl acetate/n-propanol (20:80), and isopropanol double rubs. Results are shown in Table 2 below.

### Comparative Example 3′

A 48-μ transparent oriented polypropylene film was coated with a solvent-based red (polyurethane/nitrocellulose) liquid ink (Flexomax, Sun Chemical) containing 10% epoxy acrylate (Ebecryl 3700, Surface Specialties, Syrmna, Ga.) using a 200 line per inch (lpi) flexographic hand-proofer and dried using a hot air gun. Gloss measurement and solvent resistance test were performed as described above. Results are shown in Table 2 below.

### Example 3

A 48-μ transparent oriented polypropylene film was coated with a solvent-based red (polyurethane/nitrocellulose) liquid ink (Flexomax, Sun Chemical) containing 10% polyester acrylate (Ebecryl 812, Surface Specialties, Syrmna, Ga.) using a 200 line per inch (lpi) flexographic hand-proofer and dried using a hot air gun. The ink was subsequently electron beam cured (AEB, lab-100, Wilmington, Mass.) at 3 Mrads using 100 kV acceleration voltage and less than 200 ppm O₂. Gloss measurement and solvent resistance test were performed as described above. Results are shown in Table 2 below.

TABLE 2

| | Comparative | Comparative | |
|---|---|---|---|
| Property | Example 3 | Example 3′ | Example 3 |
| 60° Gloss¹ | F | F | G |
| Transparency | F | F | F |
| n-propyl acetate/n- | P | P | G |
| propanol (20:80) | | | |
| resistance² | | | |
| Water resistance² | G | G | E |
| Isopropanol resistance² | P | F | G |

¹Gloss: 85-88 = poor (P); 89-91 = fair (F); 92-94 = good (G); and 95-97 = excellent (E).
²Solvent resistance: 0-1 double rub (a rub back and forth) = P; 2-4 = F; 5-9 = G; >10 = E.

### 6. EQUIVALENTS

Those skilled in the art will recognize, or be able to ascertain many equivalents to the specific embodiments of the invention described herein using no more than routine experimentation. Such equivalents are intended to be encompassed by the following claims.

All publications and patents mentioned in this specification are herein incorporated by reference into the specification.

What is claimed is:

1. A printing ink comprising:
(i) a solvent-soluble resin;
(ii) an energy curable monomer, oligomer, or mixture thereof; and
(iii) a vehicle.

2. The printing ink of claim 1, wherein the energy curable monomer, oligomer, or mixture thereof, is an ethylenically unsaturated monomer, oligomer, or mixture thereof.

3. The printing ink of claim 1, wherein the energy curable monomer, oligomer, or mixture thereof, is in an amount of about 1% to 50% by weight of the printing ink.

4. The printing ink of claim 1, wherein the solvent-soluble resin is in a range between about 0.1% to about 40% by weight of the printing ink.

5. The printing ink of claim 4, wherein the solvent-soluble resin comprises nitrocellulose, acrylate, methacrylate, polyester, polyamide, copolymer of styrene and maleic anhydride, polyurethane and epoxy.

6. The printing ink of claim 1, wherein the vehicle comprises water, methanol, ethanol, n-propanol, iso-propanol, n-butanol, sec-butanol, tert-butanol, iso-butanol, n-pentanol, or ethyl acetate.

7. The printing ink of claim 1 further comprising a photoinitiator.

8. The printing ink of claim 7, wherein the photoinitiator is in an amount between about 0.1% and about 20% by weight of the printing ink.

9. The printing ink of claim 7, wherein the photoinitiator is selected from the group consisting of benzophenone, acetophenone, fluorenone, xanthone, thioxanthone, carbazole, benzoin, the allyl benzoin ethers, 2- or 3 or 4-bromoacetophenone, 3- or 4-allylacetophenone, m- or p-diacetylbenzene, 2- or 3- or 4-methoxybenzophenone, 3,3′- or 3,4′- or 4,4′-dimethoxybenzophenone, 4-chloro-4′-benzylbenzophenone, 2- or 3-chloroxanthone, 3,9-dichloroxanthone, 2- or 3-chlorothioxanthone, 3-chloro-8-nonylxanthone, 3-methoxyanthone, 3-iodixanthone, 2-acetyl-4-methylphenyl acetate, alkyl and aryl ethers of benzoin, phenylglyoxal alkyl acetals, 2,2′-dimethoxy-2-phenyl-acetophenone, 2,2-diethoxyacetophenone, 2,2-diiso-propoxyacetophenone, 1,3-diphenyl acetone, naphthalene sulfonyl chloride, and mixtures thereof.

10. A method of printing comprising:
(i) printing a substrate with the printing ink of claim 1;
(ii) drying the printed ink; and
(iii) exposing the printed ink to an actinic radiation.

11. The method of claim 10, wherein steps (ii) and (iii) are performed sequentially.

12. The method of claim 10, wherein steps (ii) and (iii) are performed simultaneously.

13. The method of claim 10, wherein the actinic radiation is an electron beam.

14. The method of claim 10, wherein the printing ink further comprising a photoinitiator.

15. The method of claim 14, wherein the actinic radiation is a ultraviolet light.

16. The method of claim 14, wherein the photoinitiator is selected from the group consisting of benzophenone, acetophenone, fluorenone, xanthone, thioxanthone, carbazole, benzoin, the allyl benzoin ethers, 2- or 3- or 4-bromoacetophenone, 3- or 4-allylacetophenone, m- or p-diacetylbenzene, 2- or 3- or 4-methoxybenzophenone, 3,3′- or 3,4′- or 4,4′-dimethoxybenzophenone, 4-chloro-4′-benzylbenzophenone, 2- or 3-chloroxanthone, 3,9-dichloroxanthone, 2- or 3-chlorothioxanthone, 3-chloro-8-nonylxanthone, 3-methoxyanthone, 3-iodixanthone, 2-acetylmethylphenyl acetate, alkyl and aryl ethers of benzoin, phenylglyoxal alkyl acetals, 2,2′-dimethoxy-2-phenyl-acetophenone, 2,2-diethoxyacetophenone, 2,2-diiso-propoxyacetophenone, 1,3-diphenyl acetone, naphthalene sulfonyl chloride, and mixtures thereof.

17. The method of claim 10, wherein the energy curable monomer, oligomer, or mixture thereof, is an ethylenically unsaturated monomer, oligomer, or mixture thereof.

18. The method of claim 10, wherein the energy curable monomer, oligomer, or mixture thereof, is in an amount of about 1 to 50% by weight of the printing ink.

19. The method of claim 10, wherein the solvent-soluble resin is in an amount of about 0.1% and about 40% by weight of the total ink.

20. The method of claim 10, wherein the vehicle comprises water, methanol, ethanol, n-propanol, iso-propanol, n-butanol, sec-butanol, tert-butanol, iso-butanol, n-pentanol, or ethyl acetate.
